(19) United States
(12) Patent Application Publication
(10) Pub. No.: US 2016/0135373 A1
(43) Pub. Date: May 19, 2016

(54) COVER PLATE FOR A PROCESSING CHAMBER

(71) Applicant: FORAGE INNOVATIONS B.V., Maassluis (NL)

(72) Inventors: Tobias KEUNE, Maassluis (NL); Willem Jacobus REIJERSEN VAN BUUREN, Maassluis (NL)

(73) Assignee: FORAGE INNOVATIONS B.V., Maassluis (NL)

(21) Appl. No.: 14/898,364

(22) PCT Filed: Jul. 7, 2014
(86) PCT No.: PCT/NL2014/050456

§ 371 Date: Dec. 14, 2015

(30) Foreign Application Priority Data
Jul. 17, 2013 (NL) 2011180

(51) Int. Cl. A01F 15/08; E06B 3/34

(52) U.S. Cl. CPC A01F 15/08; E06B 3/34

(57) ABSTRACT

An arrangement includes a processing chamber, at least one cover plate for the processing chamber, and a holding assembly. The holding assembly is arranged to hold the cover plate at an outer surface of the processing chamber. A method for operating such an arrangement is disclosed. The holding arrangement guides the cover plate with respect to the processing chamber from a covering position into an access-enabling position and back from the access-enabling position into the covering position. The cover plate in the covering position covers a part of the outer surface of the processing chamber. The distance between the cover plate in the access-enabling position and the processing chamber occurs. The cover plate is moved from the covering position into the access-enabling position along a curved opening trajectory. This opening trajectory is horizontal or is sloping with respect to the ground.

### 1. FIELD OF THE INVENTION

The invention refers to an arrangement comprising a processing chamber, a cover plate for the processing chamber, and a holding assembly arranged to hold the cover plate and to guide the moved cover plate along a curved trajectory. In one application the arrangement processes loose material in the processing chamber.

### 2. BACKGROUND OF THE INVENTION

In WO 2012/022666 A1 a panel arrangement for a harvesting machine is described. A horizontal walkway 5 extends along the roof of a processing chamber of the harvester 1. A forage harvester 1 is covered by a left side panel 4c and two right-side panels 4a and 4b, cf. FIG. 1 to FIG. 4. A panel 4a can be shifted up and lowered down in a vertical direction independently from panel 4b, cf. FIG. 1 and FIG. 2. The entire panel 4c can be shifted up and lowered down, cf. FIG. 3 and FIG. 4. FIG. 5 and FIG. 6 show the harvester 1 with the panels 4a and 4c from the rear, where the panels 4a and 4c are in a closed position (FIG. 5) and in a lifted opened position (FIG. 6). In the opened position the roof walk way 5 is between the panels 4a and 4c. The panels 4a and 4c are pivoted towards each other. They form two arc-shaped objects like street lamps, cf. FIG. 6. A linkage mechanism 17 connects a frame 18 of the left panel 4c with the chassis of the harvester 1, cf. FIG. 7a to FIG. 7c. This linkage mechanism 17 comprises an upper bracket 19 and a lower bracket 20 which are connected by an upper link 21 and a lower link 22, cf. FIG. 8. A spring means 23, e. g. a gas spring with a cylinder, connects the upper link 21 with the chassis, cf. FIG. 9 (partially open) and FIG. 10 8 (entirely open).

EP 0224708 A1 discloses a harvester 10 with a cleaning device 16, cf. FIG. 1 and FIG. 3. A protecting device 28 covers several pulleys 24 guiding several belts, cf. FIG. 3. The protecting device 28 comprises a platform 34 and a shield (Schutzteil 32). The platform 34 is pivotally connected at the lower edge of the harvester's frame and can be pivoted between a vertical position and a horizontal position. In the vertical position the platform 34 covers the cleaning device 16. In the horizontal position an operator can stand on the platform 34 and can perform maintenance work. Two parallel guiding members (Lenkeranordnungen 36, 38) connect the outer edge of the pivotal platform 34 with the harvester's frame and are arranged as parallelogram guiders 52, 54. The shield 32 is pivotally connected with the outer edge of the platform 34 and remains in a vertical orientation in both positions of the platform 34.

DE 2111140 A1 discloses a foldable ladder (“Faltleiter”) which is mounted at a vehicle, in particular at a combine harvester 1 (“Mändrescher 1”). A fixed part A of the ladder is mounted at the combine harvester 1. A movable part B of the ladder is pivotally connected with the fixed part A and can be moved upwards and downwards with respect to the fixed part A. In the lower position the movable part B extends the fixed part A such that the parts A and B together provide a sequence of step treads (“Trittstufen 4, 10”). When being shifted into the upper position, the part B is besides the fixed part A. Several elements 14, 15, 16, 21 are pivotally connected with the fixed part A and the movable part B.

The company Welger has presented a stationary recycling processing machine with the name SB 3000. A door is pivotally mounted at a chassis by means of a parallelogram-shaped connected unit. The door can be shifted in a horizontal plane.

EP 1394344 A1 discloses an arrangement with a body 11 of a cabin and a door 12 for this cabin, cf. FIG. 1. The door 12 is supported by a pair of links 15, 16. The links 15, 16 can pivot with respect to the cabin body 11 around two vertical shafts 13, 14. The links 15, 16 are also pivotally mounted at the door 12. A front locking mechanism 19 and a rear locking mechanism 12 can lock the door 12, cf. the continuous lines in FIG. 1.

### 3. SUMMARY OF THE INVENTION

A problem solved by the invention is to provide an arrangement with the features of the preamble of claim 1 and an operating method with the features of the preamble of claim 21 wherein less force for moving the cover plate from the covering position into the access-enabling position is required.

This problem is solved by an arrangement with the features of claim 1 and an arrangement operating method with the features of claim 21. Preferred embodiments are specified in the depending claims.

The invention refers to an arrangement comprising a processing chamber, at least one cover plate for the processing chamber, and a holding assembly. Material being in the processing chamber is processed. The holding assembly is arranged to hold the cover plate at the processing chamber. The cover plate is pivotally mounted at the processing chamber by means of the holding assembly. The cover plate is arranged outside of the processing chamber, i.e. at an outer surface of the processing chamber. The invention further refers to a method for operating such an arrangement.

The holding assembly guides the cover plate with respect to the processing chamber from a covering position into an access-enabling position and back from the access-enabling position into the covering position. The cover plate in the covering position covers a part of the processing chamber. A distance between the cover plate in the access-enabling position and the processing chamber occurs. The cover plate is guided from the covering position into the access-enabling position along a curved opening trajectory. According to the invention this opening trajectory is horizontal or is sloping with respect to the ground.

### 4. ADVANTAGES

The cover plate in the covering position covers a part of a processing arrangement. In particular for performing maintenance or service operations, it is necessary that a human operator obtains access to the covered part of the processing chamber. Therefore the cover plate can be opened and moved into an access-enabling position.

The holding assembly and the cover plate are mounted outside of the outer surface of the processing chamber. Neither the holding assembly nor the cover plate comes in contact with material in the processing chamber. It is possible to arrange processing members inside the processing chamber wherein the processing members process under pressure loose material in the processing chamber. Or the processing members apply a high temperature or moisture or vacuum onto material in the processing chamber. Thanks to the cover plate it is further possible to arrange drive members for the processing members outside of the processing chamber such that the drive members do not come in contact with the material in the processing chamber. The cover plate in the covering position covers the drive members, protects these drive members, and protects a human operator. The cover plate can further protect the holding assembly.

As the holding assembly and the cover plate are mounted outside of the processing chamber, neither the cover plate nor the holding assembly comes in contact with material in the processing chamber and needs to stand dirt, moisture, heat, vacuum, or pressure applied by this material or onto this material. Therefore the cover plate can be made as a thin sheet and/or from a light material and has a low weight. It is possible to design the cover plate such that an aerodynamic shape and/or a desired esthetic styling or a desired color is achieved without reducing the processing function in the interior of the processing chamber. As the cover plate can have a small weight, also the holding assembly can be implemented with low weight.

According to the invention the holding assembly guides the cover plate along a curved trajectory. Therefore it is not necessary to open the cover plate like a flap such that the cover plate in the access-enabling position and the covered part of the processing chamber surface together form a V. In particular it is not necessary to rotate the cover plane around a horizontal axle mounted at the processing chamber. Thanks to the curved opening trajectory less space is required by the arrangement with the cover plate in the access-enabling position.

According to the invention the cover plate is moved along a curved opening trajectory into the access-enabling position. This feature leads to an arrangement with a reduced width, i.e. with a reduced dimension perpendicular to the cover plate, compared to a cover plate which can be moved into the access-enabling position by rotating the cover plate.

Thanks to the horizontal or sloping trajectory the cover plate can be moved from the covering position into the access-enabling position with less force. This advantage is achieved as the cover plate is not lifted against the force of gravity into the access-enabling position but is pivoted horizontally or only sloping upwards. The weight of the cover plate is carried by the holding assembly mounted at the processing chamber. As the opening trajectory is horizontal or is sloping upwards, only the friction and—in the case of a sloping trajectory—a lifting force smaller than the weight of the cover plate is required for moving the cover plate. This lifting force depends on the sinus of the sloping angle of the opening trajectory. This advantage is in particular relevant if a human operator has to move the cover plate manually into the access-enabling position. The invention therefore leads to a more ergonomic arrangement. Thanks to the invention it is possible but not necessary to provide the arrangement with a drive for moving the cover plate into the access-enabling position. Nevertheless the cover plate can be as strong and large as required.

A further advantage of the invention is that the height of the arrangement is only moderately enlarged or is not enlarged at all if the cover plate is moved from the covering position into the access-enabling position. A movement along a vertical opening trajectory would increase the height of the arrangement much more. Nevertheless the invention provides sufficient access to the processing chamber if the cover plate is in the access-enabling position. Thanks to the reduced height—compared with a vertical opening trajectory—the risk is reduced that the cover plate hits a roof of a workshop or a further room in which the arrangement is positioned. This risk can occur when the cover plate is moved into the access-enabling position or when the arrangement with the cover plate in the access-enabling position is moved under a roof.

### 5. PREFERED EMBODIMENTS

In one embodiment the holding assembly comprises a parallelogram guider. This embodiment distributes the weight of the cover plate to at least two different bearing units and to at least two different connecting points between the cover plate and the holding assembly. The risk is reduced that the cover plate is rotated around an axis being perpendicular to the cover plate plane. Such a rotation may damage the cover plate or may have the result that the cover plate in the covering position does not fit exactly and cannot protect as desired.

In one embodiment the holding assembly comprises three bearing units. Every bearing unit comprises a rod. These three rods are not arranged in the same plane. With other words: The three rods are connected with the processing chamber in three chamber-side connecting points. The three rods are connected with the cover plate in three cover-side connecting points. The three chamber-side connecting points form a triangle. The three cover-side connecting points form a further triangle. This embodiment provides a higher mechanical stability. The risk is further reduced that the cover plate is rotated around an axis perpendicular to the cover plate plane or that the cover plate cants.

Preferably the cover plate is mounted at a holding frame of the holding assembly. The bearing units of the holding assembly are rotatably connected with this holding frame. This embodiment saves the need to connect the bearing units directly with the cover plate. Thanks to the holding frame the cover plate can be connected with the holding frame in more than two connecting points. Thanks to the holding frame the number of the connecting points between the cover plate and the holding assembly can be larger than the number of separate bearing units of the holding assembly. The risk is reduced that the cover plate is damaged in a connecting point as the load is distributed onto several connecting points.

In one embodiment the holding assembly is arranged such that the following result is achieved: The cover plate plane is parallel to a surface plane in which the covered part of the processing chamber extends. The cover plate plane is parallel to the surface plane when the cover plate is in the covering position as well as when the cover plate is in the access-enabling position. Moving the cover plate from the covering position into the access-enabling position increases the distance between these two planes. The embodiment with the two parallel planes removes or at least reduces the risk that the cover plate hits the processing chamber while being moved from one position into the other position.

In one embodiment a position-keeping unit keeps the cover plate in the access-enabling position. It requires a moving force to overcome the retaining force of this position-keeping unit and to move the cover plate against this retaining force into the covering position. This embodiment better protects a human operator working at the processing chamber from being injured by the cover plate moving into the covering position. In particular this embodiment better prevents the undesired event that the cover plate is moved by error into the covering position while a human operator is between the cover plate in the access-enabling position and the covered part of the processing chamber surface.

In one implementation the position-keeping unit comprises a biasing element and a limiting element. The biasing element tends to move the guided cover plate along the opening trajectory into the access-enabling position. The biasing element thereby supports an operator to move the cover plate into the access-enabling position. The limiting element defines the end of the opening trajectory and thereby the access-enabling position. The cover plate can only be moved back into the covering position against the force of the biasing element. The biasing element thereby keeps the cover plate in the access-enabling position.

In one embodiment the arrangement belongs to a vehicle, e.g. to an agricultural harvester. The vehicle can be moved in a travelling direction. The holding assembly and the cover plate are mounted laterally at the processing chamber. The term “laterally” refers to the travelling direction. The holding assembly is arranged for guiding the cover plate from the access-enabling position into the covering position along a closing trajectory. This closing trajectory is opposite to the opening trajectory and is opposite, e.g. anti-parallel, to the travelling direction. This means: The cover plate is moved backwards into the covering position wherein the term “backwards” refers to the travelling direction.

This embodiment reduces the risk of an accident when the vehicle is moved in the travelling direction and when the cover plate is at least temporarily in the access-enabling position while the vehicle is moved. The moved vehicle with the cover plate being in the access-enabling position has a larger width, i.e. a larger dimension perpendicular to the travelling direction, than with the cover plate being in the covering position. Because of the enlarged width the risk is increased that the cover plate being in the access-enabling position hits a human, a further living being, or an obstacle. Thanks to the embodiment the cover plate hitting the living being or the obstacle is moved backwards while the vehicle continuous to travel in the travelling direction. The cover plate does not apply a high force onto the living being or onto the obstacle. The risk is reduced that the living being, the obstacle, or the cover plate is ensured/damaged.

In one embodiment two cover plates are mounted at two outer surfaces of the processing chamber. Therefore the arrangement comprises two holding assemblies for these two cover plates. Every holding assembly guides the corresponding cover plate along a curved trajectory. Preferably these two holding arrangements are connected by a connecting member, e.g. a crossbar. In one implementation this connecting member is arranged above the processing chamber. The embodiment with the connecting member increases the mechanical stability of the arrangement. A load occurring at one holding assembly is distributed onto both holding assemblies by means of the connecting member.

Several embodiments make it easier for a human operator to get access to the processing chamber. The work for the human operator becomes even more ergonomic. The horizontal distance between the cover plate being in the access-enabling position and the processing chamber is at least 50 cm such that enough space is provided for a standing operator. The vertical distance between the cover plate being in the access-enabling position and the ground is between 1 m and 2 m. To get access to the processing chamber, the operator can pass between the cover plate and the ground. On the other hand the arrangement does not become too high. The vertical distance between the holding assembly and the ground is at least 1 m. This makes it easier for the human operator to work at the holding assembly.

In one application the cover plate being in a covering position covers a driving member at an outer surface of the processing chamber. For enabling maintenance work the cover plate can be moved into an access-enabling position. Thanks to the cover plate the driving member can be arranged outside of the processing chamber and does not come in contact with material in the processing chamber.

These and other aspects of the invention and of the preferred embodiment will be even more apparent from the detailed embodiment as described below and will be elucidated in detail there.

### 6. BRIEF DESCRIPTION OF THE DRAWINGS

FIG. 1 shows a baler comprehending the invention with the left cover plate in the covering position from a top view;

FIG. 2 shows the baler of FIG. 1 with the left cover plate in the access-enabling position;

FIG. 3 shows the baler with the left cover plate in the covering position from a side view;

FIG. 4 shows the baler of FIG. 3 with the left cover plate in the access-enabling position;

FIG. 5 shows the baler with the left cover plate in the covering position from a rear view;

FIG. 6 shows the baler of FIG. 5 with the left cover plate in the access-enabling position;

FIG. 7 shows the left cover plate in the covering position, the right cover plate in the access-enabling position, and the holding assembly;

FIG. 8 shows the two cover plates of FIG. 7 in the access-enabling position and the holding assembly.

### 7. DETAILED DESCRIPTION OF EMBODIMENT

In the embodiment the invention is used in a round baler for agricultural purposes. The baler picks up loose crop material from the ground, cuts it and conveys it into a pressing chamber.

The crop material conveyed into the pressing chamber is pressed such that a round-cylindrical bale is created in the pressing chamber. This bale has two parallel circular front faces and a circumferential surface between the two front faces. This pressing chamber serves as the processing chamber in the sense of the claims. It has the form of a drum.

Several conveying units in the pressing chamber convey the crop material along the circumferential wall of the pressing chamber. In one embodiment all conveying units comprise pressing rollers which are in contact with the crop material in the pressing chamber. In a further embodiment some conveying units comprise endless belts which are guided around several deflecting rollers. The crop material in the pressing chamber applies an expanding force onto the pressing belts.

The completed bale is wrapped with a net or a sheet. The wrapped bale is ejected out of the pressing chamber.

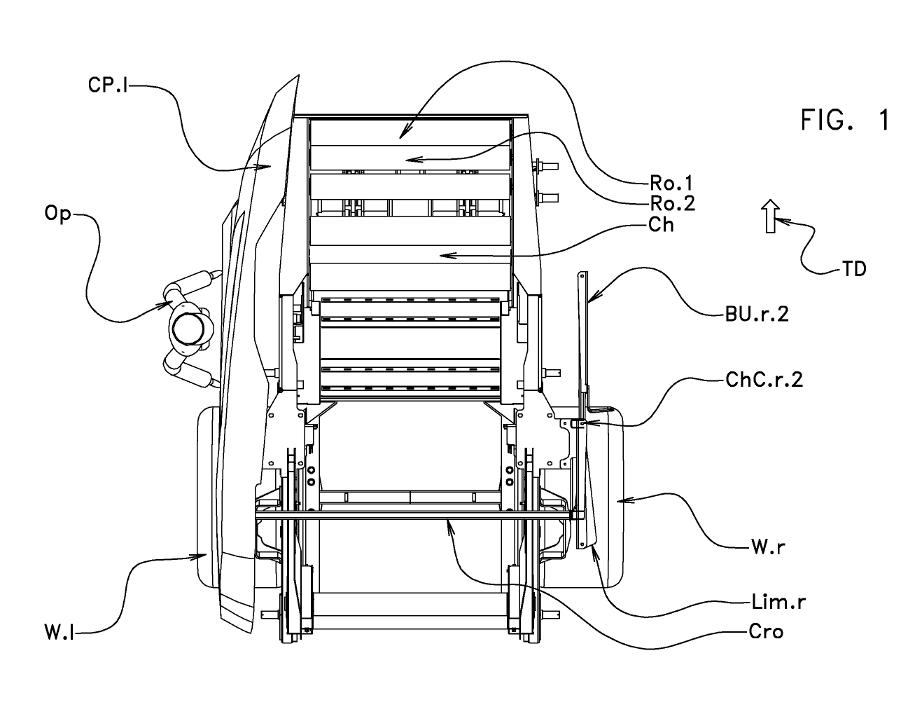

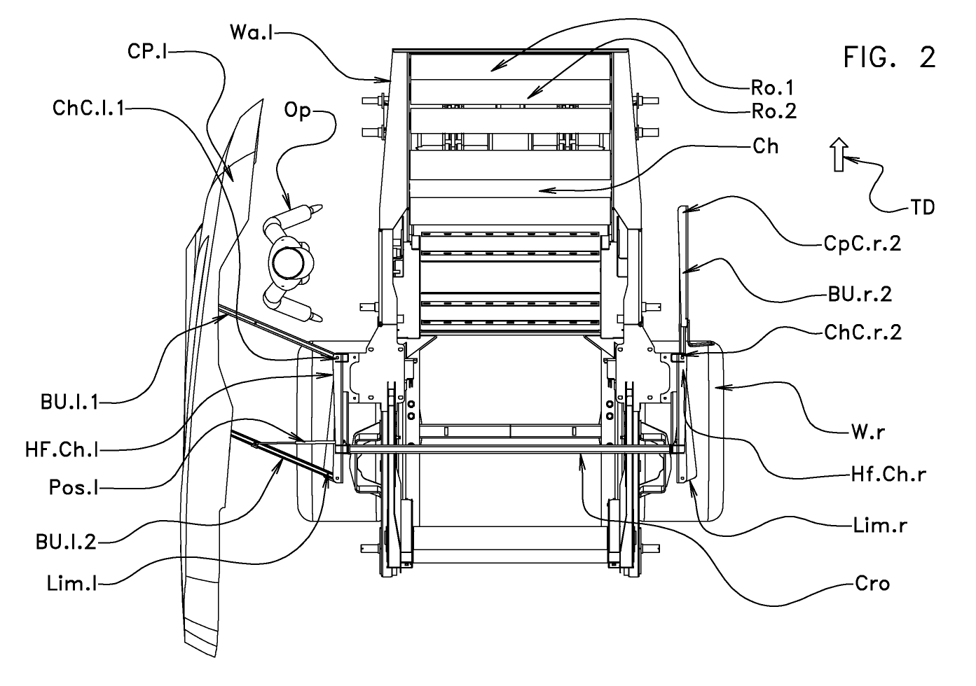

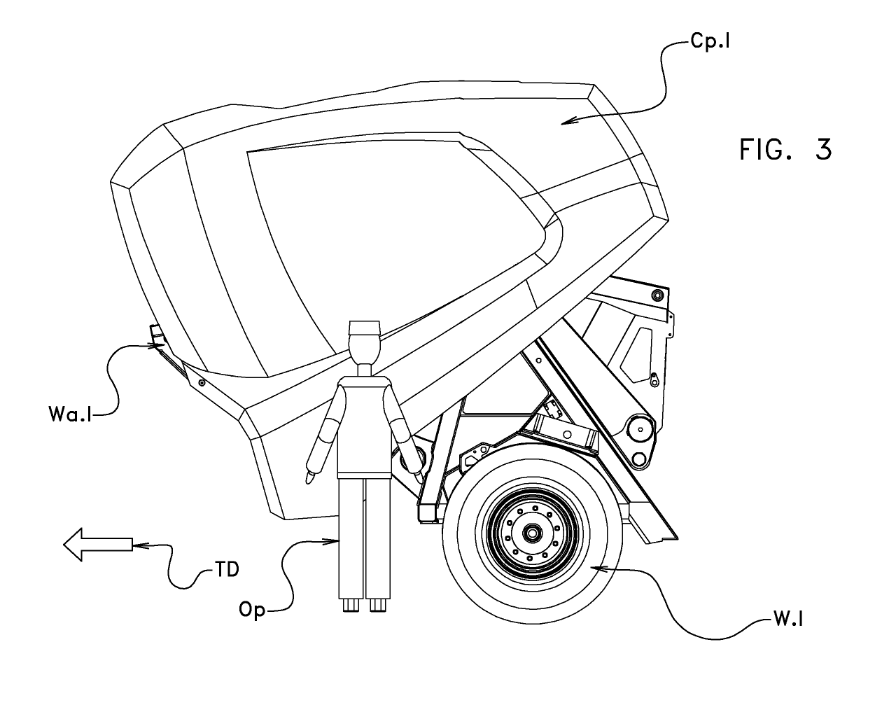

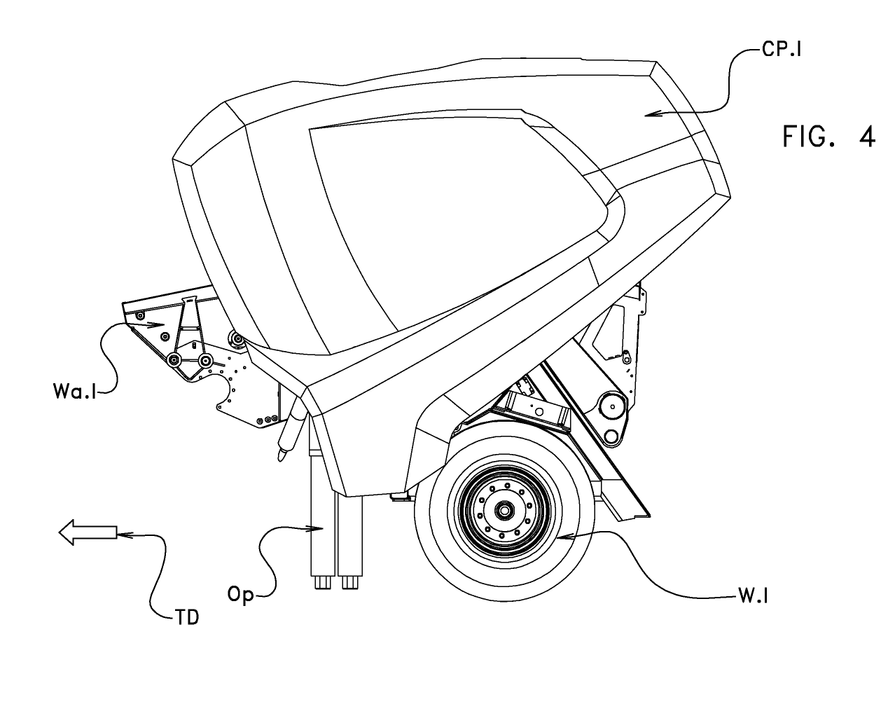

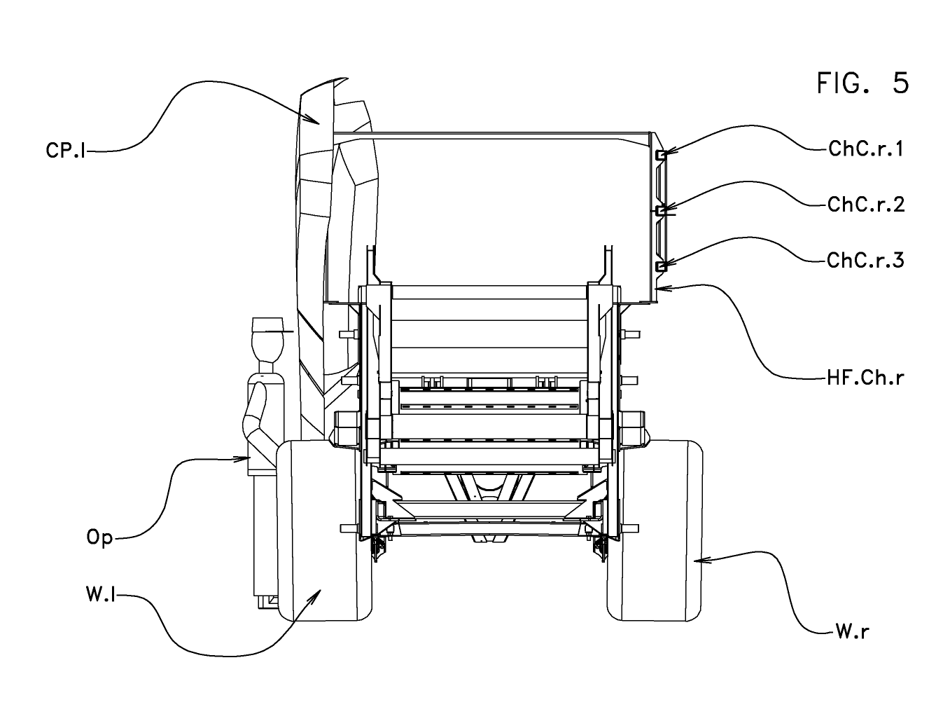

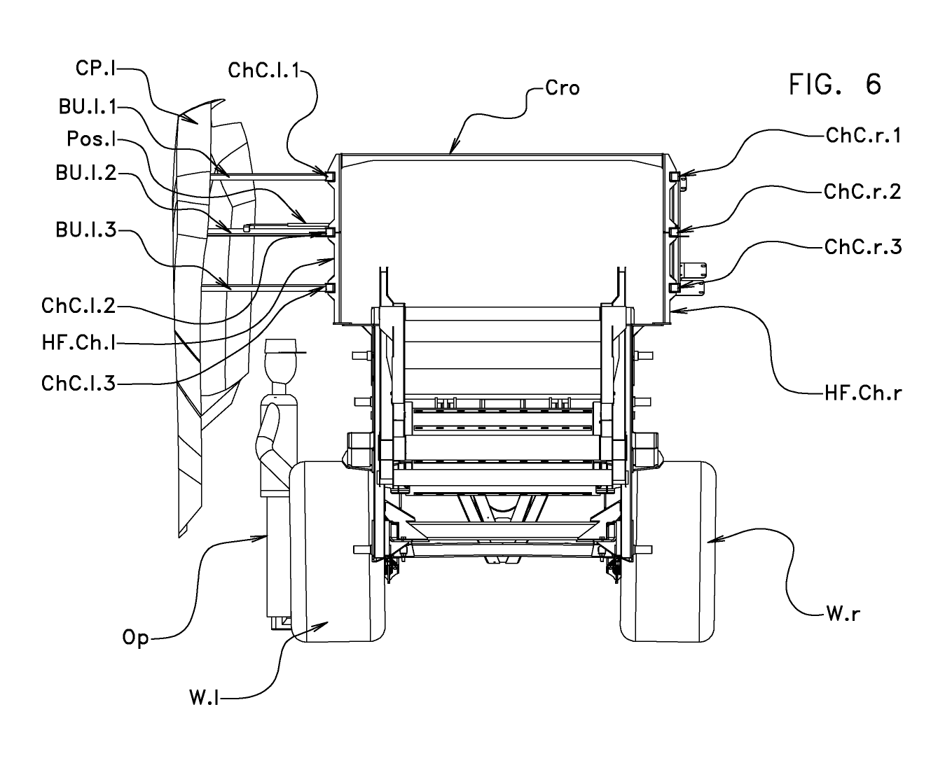

FIG. 1 to FIG. 6 show this baler from three different perspectives: from above (FIG. 1 and FIG. 2), from the left side (FIG. 3 and FIG. 4), and from behind (FIG. 5 and FIG. 6). In FIG. 1 and FIG. 2 as well as in FIG. 5 and FIG. 6 the wall of the pressing chamber Ch is omitted for sake of clarity such that several conveying units inside of the pressing chamber, among them the pressing rollers Ro.1, Ro.2, . . . , can be seen.

During operation the baler is propelled in a travelling direction TD, e.g. by a tractor. The travelling direction TD is perpendicular to the drawing plane of FIG. 5 and FIG. 6 and points away from the observer. The travelling direction TD is sketched in the other figures. The baler has no own drive for propelling the baler over ground and comprises a left wheel W.l and a right wheel W.r.

The middle axis of the pressing chamber Ch is horizontal and is perpendicular to the travelling direction TD. The pressing chamber Ch comprises a circumferential wall along which the crop material is guided and comprises two sidewalls Wa.l, Wa.r extending parallel to the travelling direction TD. The sidewalls Wa.l, Wa.r form the front faces of the drum-shaped pressing chamber Ch and serve as outer surfaces to be covered.

The pressing chamber Ch comprises a front housing and a movable tailgate. The tailgate can be rotated or otherwise pivoted around a tailgate rotating axis being perpendicular to the travelling direction TD and perpendicular to the sidewalls Wa.l, Wa.r. The front housing is rigidly mounted at the chassis.

Different working units which rotate or oscillate or otherwise move are mounted at the two sidewalls Wa.l, Wa.r and outside of the pressing chamber Ch, e.g.
chains or shafts for driving the conveying units,
hydraulic or pneumatic cylinders for opening and closing the tailgate,
a locking arrangement for connecting the tailgate with the front housing,
measuring instruments, and
a reservoir for greasing material

In FIG. 4 some working units can be seen. In addition a box with tools or manuals for a human operator can be mounted at a sidewall Wa.l, Wa.r.

To protect a human working in the environment of the baler and to protect these working units two integrally formed cover plates CP.l, CP.r are laterally mounted at the two sidewalls Wa.l, Wa.r of the pressing chamber Ch. Every cover plate CP.l, CP.r can be pivoted into an operating position and into a maintenance position. The operating position serves as the covering position in which a sidewall of the pressing chamber Ch and the working units mounted at this sidewall are covered. The maintenance position serves as the access-enabling position in which a distance between the sidewall Wa.l, Wa.r and the corresponding cover plate CP.l, CP.r occurs.

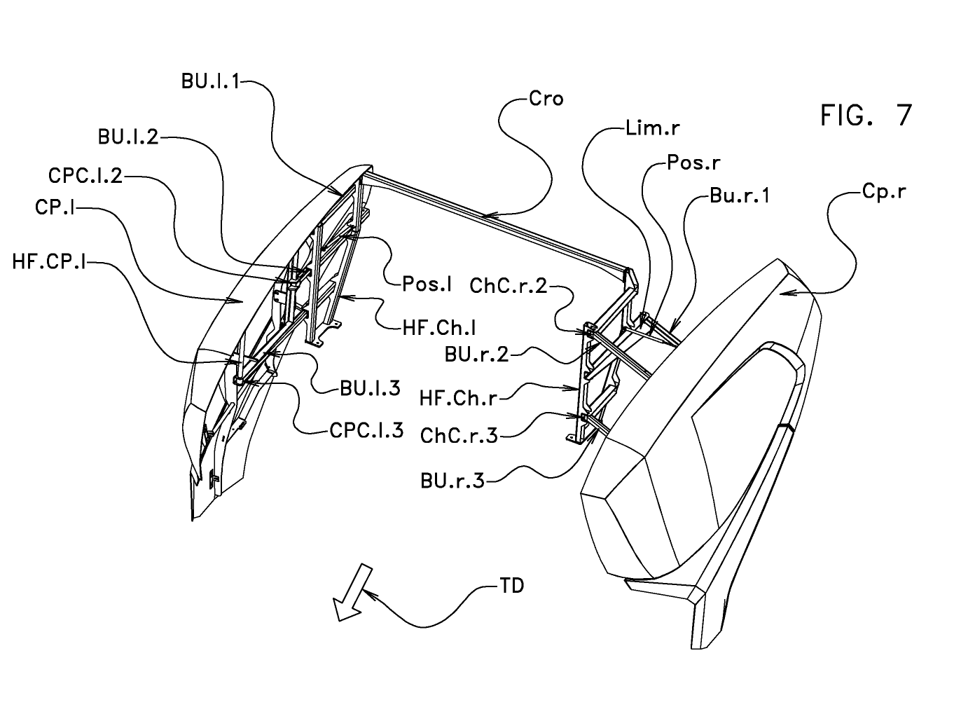

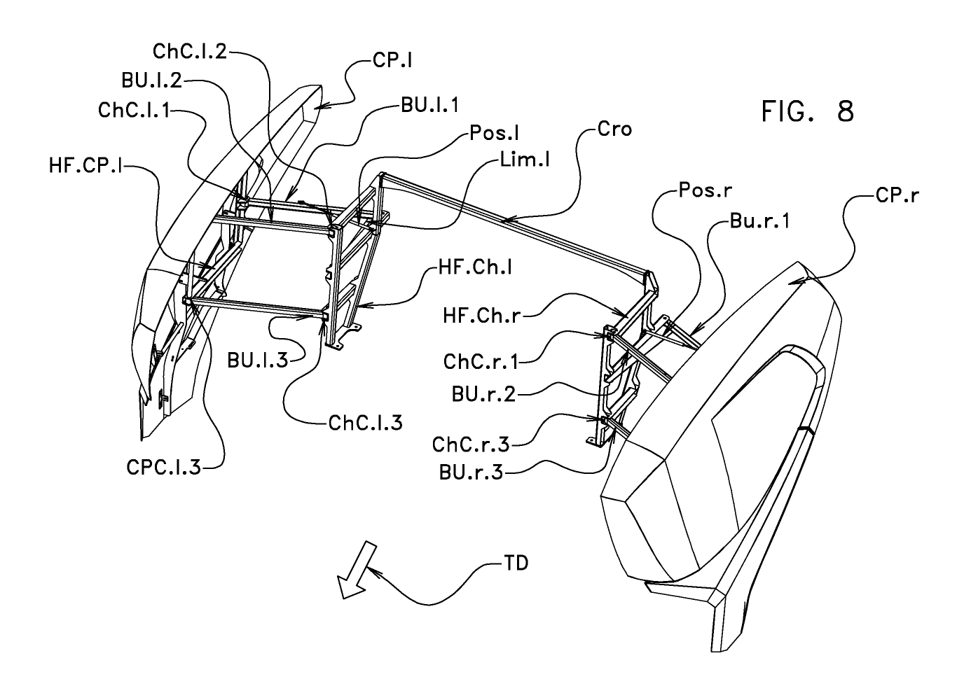

The figures show a left cover plate CP.l. FIG. 7 and FIG. 8 further show a right cover plate CP.r. In FIG. 1, FIG. 2, FIG. 5, and FIG. 6 the right cover plate CP.r is omitted for sake of clarity. In FIG. 3 and FIG. 4 the right cover plate CP.r is hidden. The left cover plate CP.l can be pivoted independently from the right cover plate CP.r.

These two cover plates CP.l, CP.r have the following functions:
They protect a human operator Op working besides the baler and further humans and animals near the baler from being injured by the working units mounted at the sidewalls Wa.l, Wa.r.
They protect the working units mounted at the sidewalls Wa.l, Wa.r of the pressing chamber Ch from dirt, rain, and pollution.
They reduce the noise emission of the baler.
They shape the contour and the styling of the baler.

The cover plates CP.l, CP.r have no supporting functions for the bale creation process. In particular they do not directly contribute to pressing crop material in the pressing chamber Ch. Therefore the cover plates CP.l, CP.r can be made of a light weight material, e.g. carbon or plastics, or can be manufactured from thin material, e.g. from a steel sheet.

In the operating position (covering position) the cover plates CP.l, CP.r cover the two sidewalls Wa.l, Wa.r. Preferably the cover plates CP.l, CP.r are locked in the operating position by means of two locking elements (not shown). These locking elements must manually be released before pivoting the cover plates CP.l, CP.r into the maintenance position (access-enabling position). This feature fulfills a requirement of the EC machine guideline.

In one embodiment releasing one cover plate CP.l, CP.r causes the working units at the sidewalls Wa.l, Wa.r and further moving or rotating units of the baler to be stopped immediately. Transferring a cover plate CP.l, CP.r out of the covering position interrupts a circuit of a security device which switches off the working units and further units.

After releasing the locking element of a cover plate CP.l, CP.r the cover plate CP.l, CP.r can be pivoted into the maintenance position (access-enabling position). In the maintenance position a space between the cover plate CP.l, CP.r and the sidewall Wa.l, Wa.r at which this cover plate CP.l, CP.r is mounted occurs. This space allows a human operator Op to stand between the pressing chamber Ch and the cover plate CP.l, CP.r and to obtain access to all working units mounted at the outer surface of this sidewall Wa.l, Wa.r. This access is possible from outside.

The cover plate CP.l, CP.r extends in a plane parallel to the plane of the sidewall Wa.l, Wa.r—in the operating position as well as in the maintenance position.

When pivoting the cover plate CP.l, CP.r from the operating position into the maintenance position, the cover plate CP.l, CP.r moves laterally away from the sidewall Wa.l, Wa.r such that this space enabling the access is provided. This lateral movement is combined with a movement parallel or anti-parallel to the travelling direction TD. The superposition of these two movements yields a curved trajectory. When being pivoted from the operating position into the maintenance position the cover plate CP.l, CP.r is moved along a curved opening trajectory. When being pivoted into the operating position the cover plate CP.l, CP.r is moved along a curved closing trajectory being inverted to the opening trajectory.

In the embodiment these two movements (lateral and parallel/anti-parallel) are both performed in a horizontal direction. In the embodiment both curved trajectories are segments of a circle in a horizontal plane. Thanks to this embodiment the baler with the cover plates CP.l, CP.r in the maintenance position has the same height than the baler with the cover plates CP.l, CP.r in the operating position. The height of the baler is therefore not increased if the cover plates CP.l, CP.r are pivoted into the maintenance position. This enables to maintain the baler in a workshop with a relative small height. No lifting force for lifting the baler against the force of gravity is required.

FIG. 1, FIG. 3, FIG. 5, and FIG. 7 show the left cover plate CP.l in the operating position (covering position). FIG. 2, FIG. 4, FIG. 6, and FIG. 8 show the left cover plate CP.l in the maintenance position (access-enabling position). FIG. 7 and FIG. 8 show the right cover plate CP.r in the maintenance position. In FIG. 1, FIG. 2, FIG. 5, and FIG. 6 the omitted or removed right cover plate CP.r is in the operating position (covering position).

Preferably every cover plate CP.l, CP.r is kept in the maintenance position by means of a position keeping unit, e.g. a spring or hydraulic or pneumatic cylinder. It requires a pivoting force to pivot the cover plate CP.l, CP.r from the maintenance position into the operating position against the force of this position keeping unit. The position keeping units prevents the cover plate CP.l, CP.r from moving into the operating position during maintenance. This movement would reduce the space between the cover plate CP.l, CP.r and the sidewall Wa.l, Wa.r and could hurt the operator Op and is therefore undesired. In the figures a left position keeping unit Pos.l and a right position keeping unit Pos.r a shown.

On the other hand the required force is so small that the following effect is achieved: If the baler is moved with the cover plate CP.l, CP.r being in the maintenance position and if the cover plate CP.l, CP.r hits during this movement a human or an obstacle, the cover plate CP.l, CP.r is pivoted towards the operating position and in a backward direction. The risk is reduced that the collision between the cover plate CP.l, CP.r and the human/obstacle leads to an injury of a human or a damage of an object.

Every cover plate CP.l, CP.r is pivotally mounted at one sidewall Wa.l, Wa.r of the pressing chamber Ch by means of a holding assembly. Seen in the travelling direction TD the baler has a left holding assembly and a right holding assembly. Every holding assembly comprises:
three bearing units,
a chamber-side holding frame, and
a cover-side holding frame.

The holding assembly for the left cover plate CP.l comprises the three left bearing units BU.l.1, BU.l.2, BU.l.3, a left chamber-side holding frame HF.Ch.l, and a left cover-side holding frame HF.CP.l. The holding assembly for the right cover plate CP.r comprises the three right bearing units BU.r.1, BU.r.2, BU.r.3, a right chamber-side holding frame HF.Ch.r, and a right cover-side holding frame HF.CP.r.

The chamber-side holding frame HF.Ch.l, HF.Ch.r is pivotally connected with the corresponding sidewall Wa.l, Wa.r of the pressing chamber Ch. Every chamber-side holding frame HF.Ch.l, HF.Ch.r comprises two vertical bearing elements and several, e. g. three, horizontal bearing elements. The cover plate CP.l, CP.r is rigidly mounted at the cover-side holding frame HF.CP.l, HF.CP.r in several mounting points. Every cover-side holding frame HF.CP.l, HF.CP.r also comprises two vertical bearing elements and several horizontal bearing elements.

In one embodiment the left chamber-side holding frame HF.Ch.l is connected with the right chamber-side holding frame HF.Ch.r by means of a traversal bearing extending along the circumferential wall and parallel to the middle axis of the pressing chamber Ch. In the figures a cross bearing Cro above the pressing chamber Ch is shown. This cross bearing Cro connects the left chamber-side holding frame HF.Ch.l with the right chamber-side holding frame HF.Ch.r.

Every rigid bearing unit BU.l.1, . . . , BU.r.1, . . . comprises a rigid rod. The three rods of one holding assembly connect the chamber side holding frame HF.Ch.l, HF.Ch.r with the cover-side holding frame HF.CP.l, HF.CP.r and are pivotally mounted at these holding frames. Preferably the three rods are mounted such that they are parallel to each other in the operating position as well as in the maintenance position but are not all in the same plane. The three chamber-side connecting points form a triangle. The three cover-side connecting points form a further triangle. In one embodiment the three rods of a holding assembly all have the same lengths.

Every bearing unit BU.l.1, . . . , BU.r.1, . . . is connected with the chamber-side holding frame HF.Ch.l, HF.Ch.r in a chamber-side connecting point and with the cover-side holding frame HF.CP.l, HF.CP.r in a cover-side connecting point. The rod extends between these two connecting points. The bearing unit BU.l.1 extends between the chamber-side connecting point ChC.l.1 and the cover-side connecting point CPC.l.1.

A chamber-side hinge mounted in the chamber-side connecting point allows the bearing unit BU.l.1, . . . , BU.r.1, . . . to rotate around the vertical chamber-side rotating axis with respect to the sidewall Wa.l, Wa.r of the pressing chamber Ch. This chamber-side rotating axis hits the chamber-side connecting point. A cover-side hinge mounted in the cover-side connecting point allows the bearing unit BU.l.1, . . . , BU.r.1, . . . to rotate around the vertical cover-side rotating axis with the respect to the cover-side holding frame HF.CP.l, HF.CP.r carrying the cover plate CP.l, CP.r. This cover-side rotating axis hits the cover-side connecting point. This embodiment of the holding assembly implements a parallelogram-shaped holding and guiding structure. The bearing units BU.l.1, . . . , BU.r.1, . . . themselves are preferably rigidly constructed and arranged such that the distance between a chamber-side connecting point and the corresponding cover-side connecting point remains constant during pivoting of the cover plate CP.l, CP.r from one position into the other position.

In one embodiment the position keeping unit Pos.l, Pos.r is connected with the chamber-side holding frame HF.Ch.l, HF.Ch.r, e.g. with a vertical bearing element, and with one bearing unit. The left position-keeping unit Pos.l is connected with the left chamber-side holding frame HF.Ch.l and the bearing unit BU.l.1. Every position keeping unit Pos.l, Pos.r further operates as a positioning unit which supports the step of pivoting the corresponding cover plate CP.l, CP.r into the maintenance position. The positioning unit Pos.l, Pos.r tends to pivot the corresponding cover plate CP.l, CP.r into the maintenance position. Pivoting the cover plate CP.l, CP.r into the covering position (operating position) has to be performed against the retaining force of the positioning unit Pos.l, Pos.r. The positioning unit Pos.l, Pos.r is implemented as a hydraulic or pneumatic cylinder or a pressure spring, e. g., and aims to extend. Therefore the positioning unit Pos.l, Pos.r rotates the bearing unit BU.l.1, BU.r.1 away from the chamber-side holding frame HF.Ch.l, HF.Ch.r and keeps the corresponding cover plate CP.l, CP.r in the maintenance position.

A limiting element limits the rotating of the bearing unit BU.l.1, BU.r.1 around the vertical chamber-side rotating axis. In the figures a left limiting element Lim.l and a right limiting element Lim.r are shown. Thanks to this limiting element Lim.l, Lim.r the angle between the three parallel bearing units BU.l.1, . . . , BU.r.1, . . . and the plane of the chamber-side holding frame HF.Ch.l, HF.Ch.r can only vary between 0 degrees (operating position) and a given maximum threshold of e. g. 70 degrees or 90 degrees (maintenance position). The positioning unit Pos.l, Pos.r presses the connected bearing unit BU.l.1, BU.r.1 against the corresponding limiting element Lim.l, Lim.r. When being pivoted into the maintenance position the cover plate CP.l, CP.r moves simultaneously forward (seen in the travelling direction TD) and away from the pressing chamber Ch until the angle between the parallel bearing units BU.l.1, . . . , BU.r.1, . . . and the chamber-side holding frame HF.Ch.l, HF.Ch.r has reached the maximum threshold. When being pivoted back into the operating position the cover plate CP.l, CP.r moves simultaneously backwards, i.e. anti-parallel to the travelling direction TD, and towards the pressing chamber Ch. As mentioned above this movement towards the operating position can be enforced if the baler is moved with the cover plates CP.l, CP.r in the maintenance position and if a cover plate CP.l, CP.r hits a human or an obstacle.

As mentioned above every cover plate CP.l, CP.r is pivoted along a horizontal curved opening trajectory into the maintenance position and along a horizontal curved closing trajectory into the operating position. As these trajectories are horizontal no pivotal movement has to be performed against the force of gravity. It is also possible that the opening trajectory is sloping upwardly and the closing trajectory is sloping downwardly.

In one embodiment a human operator Op pulls at a cover plate CP.l, CP.r. This pulling causes the cover plate CP.l, CP.r to be moved from the operating position into the maintenance position. The human operator Op has to release the cover plate CP.l, CP.r and to exert a low pulling force for opening the cover plate CP.l, CP.r. The positioning unit Pos.l, Pos.r supports the transition of the cover plate CP.l, CP.r into the maintenance position. To pivot the cover plate CP.l, CP.r back into the operating position the human operator Op pushes at the opened cover plate CP.l, CP.r and has to surpass the force exerted by the position keeping unit.

In a further embodiment a double-acting positioning unit pivots the cover plate CP.l, CP.r into the maintenance position and into the operating position. This positioning means can be actuated by the operator Op by pressing a button, e. g.

Reference signs used in the claims will do not limit the scope of the claimed invention. The term “comprises” does not exclude other elements or steps. The articles “a”, “an”, and “one” do not exclude a plurality of elements. Features specified in several depending claims may be combined in an advantageous manner.

### 8. LIST OF REFERENCE SIGNS

| | |
|---|---|
| BU.l.1, | bearing units for the left cover plate CP.l |
| BU.l.2, | |
| BU.l.3 | |
| BU.r.1, | bearing units for the right cover plate CP.r |
| BU.r.2, | |
| BU.r.3 | |
| Ch | bale pressing chamber, serves as the processing chamber |
| ChC.l.1, | chamber-side connecting points for the left bearing units |
| ChC.l.2, | BU.l.1, BU.l.2, BU.l.3 |
| ChC.l.3 | |
| ChC.r.1, | chamber-side connecting points for the right bearing units |
| ChC.r.2, | BU.r.1, BU.r.2, BU.r.3 |
| ChC.r.3 | |
| CP.l | left cover plate |
| CP.r | right cover plate |
| CPC.l.1, | cover-side connecting points for the left bearing units |
| CPC.l.2, | BU.l.1, BU.l.2, BU.l.3 |
| ChC.l.3 | |
| CPC.r.1, | cover-side connecting points for the right bearing units |
| CPC.r.2, | BU.r.1, BU.r.2, BU.r.3 |
| CPC.r.3 | |
| Cro | cross bearings for the two chamber-side holding frames |
| | HF.Ch.l, HF.Ch.r |
| HF.Ch.l | left chamber-side holding frame |
| HF.Ch.r | right chamber-side holding frame |
| HF.CP.l | left cover-side holding frame |
| HF.CP.r | right cover-side holding frame |
| Lim.l | limiting element for the left cover plate CP.l |
| Lim.r | limiting element for the right cover plate CP.r |
| Op | human operator, pushes and pulls the cover plate CP.l, CP.r |
| Pos.l | left position keeping unit |
| Pos.r | right position keeping unit |
| Ro.1, Ro.2, | pressing rollers inside the pressing chamber Ch |
| . . . | |
| TD | travelling direction of the baler |
| W.l | left wheel |
| W.r | right wheel |
| Wa.l | left sidewall of the pressing chamber Ch |
| Wa.r | right sidewall of the pressing chamber Ch |

1. An arrangement comprising:
a processing chamber;
at least one cover plate for the processing chamber; and
a holding assembly arranged to hold the cover plate at an outer surface of the processing chamber,
wherein the processing chamber is arranged to process material being in the processing chamber,
wherein the holding assembly is arranged to guide the cover plate with respect to the processing chamber along a curved opening trajectory from a covering position into an access-enabling position and back from the access-enabling position into the covering position,
wherein the cover plate being in the covering position covers a part of the outer surface of the processing chamber, and
wherein a distance between the cover plate being in the access-enabling position and the processing chamber occurs, the holding assembly is arranged such that the opening trajectory is horizontal or is sloping upwards with respect to the ground.

2. The arrangement according to claim 1, wherein the holding assembly comprises first and second bearing units,
wherein every bearing unit is pivotally connected with the processing chamber and is pivotally connected with the cover plate, and
wherein a distance the two bearing units occurs.

3. The arrangement according to claim 2, wherein every bearing unit is connected with the processing chamber such that the bearing unit can rotate with respect to the processing chamber around a chamber-side rotating axis, and
wherein the chamber-side rotating axis is arranged vertically or is sloping with respect to the ground.

4. The arrangement according to claim 2, wherein every bearing unit is connected with the cover plate such that the bearing unit can rotate with respect to the cover plate around a cover-side rotating axis, and
wherein the cover-side rotating axis is arranged vertically or is sloping with respect to the ground.

5. The arrangement according to claim 2, wherein the first bearing unit is arranged vertically or angularly above the second bearing unit.

6. The arrangement according to claim 2, wherein the holding assembly comprises three bearing units,
wherein every bearing unit comprises a rod, and
wherein the three rods of the three bearing units are not arranged in the same plane.

7. The arrangement according to claim 2, wherein the holding assembly comprises a holding frame,
wherein every bearing unit of the holding assembly is rotatably connected with the holding frame, and
wherein the holding frame is connected with the cover plate.

8. The arrangement according to claim 1, wherein the holding assembly comprises a position-keeping unit, and
wherein the position-keeping unit tends to keep the cover plate in the access-enabling position.

9. The arrangement according to claim 1, wherein the holding assembly comprises a limiting element, and
wherein the limiting element limits the guided movement of the cover plate along the opening trajectory.

10. The arrangement according to claim 9, wherein the holding assembly comprises a biasing element, and
wherein the biasing element applies a biasing force onto the cover plate, the biasing force to press the cover plate against the limiting element and thereby keeping the cover plate in the access-enabling position.

11. The arrangement according to claim 1, wherein the horizontal distance between the cover plate being in the access-enabling position and the processing chamber is at least 50 cm.

12. The arrangement according to claim 1, wherein the vertical distance between the cover plate being in the access-enabling position and the ground is between 1 m and 2 m.

13. The arrangement according to claim 1, wherein the vertical distance between the holding assembly and the ground is at least 1 m.

14. The arrangement according to claim 1, wherein the covered part of the processing chamber extends in a surface plane and the cover plate extends in a cover plane, and
wherein the cover plane is parallel to the surface plane in both positions of the cover plate.

15. The arrangement according to claim 1, further comprising:
at least one driving member; and
at least one processing member,
wherein the driving member is arranged outside of the processing chamber,
wherein the processing member is arranged in the interior of the processing chamber,
wherein the driving member is arranged to drive the processing member, and
wherein the cover plate being in the covering position covers the driving member.

16. The arrangement according to claim 1, further comprising:
a further cover plate for the processing chamber;
a further holding assembly arranged to hold the further cover plate at a further outer surface of the processing chamber; and
a connecting member,
wherein the further holding assembly is arranged to guide the further cover plate along a further horizontal or sloping opening trajectory, and
wherein the connecting member connects the two holding assemblies.

17. The arrangement according to claim 16,
wherein the connecting member is arranged above the processing chamber.

18. A vehicle comprising:
the arrangement according to claim 1,
wherein the vehicle is moveable in a travelling direction; and
wherein the holding assembly and the cover plate are mounted—with respect to the travelling direction—laterally at the processing chamber.

19. The vehicle according to claim 18, wherein the holding assembly is arranged to guide the cover plate from the access-enabling position into the closing position along a curved closing trajectory, and
wherein the closing trajectory is opposite to the travelling direction.

20. The vehicle according to claim 18, further comprising:
a pick-up unit arranged to pick-up loose material from the ground;
a conveying member arranged to convey picked-up loose material into the processing chamber; and
presser arranged to press a bale from loose material in the processing chamber.

21. A method for operating an arrangement, wherein the arrangement comprises:
a processing chamber;
at least one cover plate for the processing chamber; and
a holding assembly arranged to hold the cover plate at an outer surface of the processing chamber,
wherein the method comprises the steps of:
processing material being contained in the processing chamber while the cover plate is in a covering position and covers a part of the outer surface of the processing chamber;
guiding the cover plate with the holding assembly during a movement along a curved opening trajectory from the covering position into an access-enabling position such that a distance between the cover plate being in the access-enabling position and the process chamber occurs; and
guiding the cover plate with the holding assembly back from the access-enabling position into the covering position,
wherein the holding assembly guides the cover plate such that the curved opening trajectory is horizontal or is sloping upwards with respect to the ground.

22. The method according to claim 21, further comprising the steps of:
moving the arrangement over ground in a travelling direction, such that the holding assembly and the cover plate are mounted—with respect to the travelling direction—laterally at the processing chamber, wherein the cover plate is at least temporarily in the access-enabling position while the arrangement is moved in the travelling direction; and
guiding the cover plate with the holding assembly from the access-enabling position into the closing position along a curved closing trajectory, wherein the closing trajectory is opposite to the travelling direction.
